(19) United States
(12) Patent Application Publication
(10) Pub. No.: US 2024/0170767 A1
(43) Pub. Date: May 23, 2024

(54) TRACTION BATTERY PACKS WITH INTEGRATED THERMAL BARRIER SYSTEMS

(71) Applicant: FORD GLOBAL TECHNOLOGIES, LLC, Dearborn, MI (US)

(72) Inventors: Bhaskara Rao BODDAKAYALA, Troy, MI (US); Giriraj SRINIVASAN, Troy, MI (US)

(21) Appl. No.: 18/056,313

(22) Filed: Nov. 17, 2022

(51) Int. Cl. H01M 10/658; B60L 50/60; B60L 50/64; B60L 58/24; H01M 10/613; H01M 10/6554; H01M 50/209; H01M 50/298; H01M 50/502

(52) U.S. Cl. CPC H01M 10/658; B60L 50/64; B60L 50/66; B60L 58/24; H01M 10/613; H01M 10/6554; H01M 50/209; H01M 50/298; H01M 50/502; H01M 2220/20

(57) ABSTRACT

Battery thermal barrier systems are provided for traction battery packs. Exemplary battery thermal barrier systems may include one or more components that include a foam portion and an endothermic aerogel system configured to mitigate the effects of battery thermal events. The components may include bifurcation structures, canopy structures, thermal barrier plates, or combinations thereof.

### TECHNICAL FIELD

This disclosure relates generally to electrified vehicle traction battery packs, and more particularly to traction battery packs having integrated thermal barrier systems designed for mitigating the effects of battery thermal events.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, an enclosure assembly, a first battery array housed within the enclosure assembly, and a thermal barrier system including a component arranged to interface with at least one of the enclosure assembly or the first battery array. The component includes a foam portion and an endothermic aerogel system.

In a further non-limiting embodiment of the foregoing traction battery pack, the component of the thermal barrier system includes a bifurcation structure that is positioned between the first battery array and a second battery array.

In a further non-limiting embodiment of either of the foregoing traction battery packs, the bifurcation structure includes a mounting pedestal extending between the first battery array and the second battery array, and a partition arranged to seal an interface between the first battery array, the second battery array, and a bus bar assembly.

In a further non-limiting embodiment of any of the foregoing traction battery packs, the component of the thermal barrier system includes a canopy structure arranged to cover at least a portion of a bus bar assembly that electrically couples the first battery array to a second battery array.

In a further non-limiting embodiment of any of the foregoing traction battery packs, the canopy structure and a bifurcation structure of the thermal barrier system cooperate to isolate a first portion of an interior of the enclosure assembly where the first battery array resides from a second portion of the interior where the second battery array resides.

In a further non-limiting embodiment of any of the foregoing traction battery packs, the component of the thermal barrier system includes a canopy structure arranged to cover a sensitive component of the first battery array.

In a further non-limiting embodiment of any of the foregoing traction battery packs, the canopy structure includes a first arm that is arranged to contact a wall of an enclosure tray of the enclosure assembly, and a second arm that is arranged to contact an upper surface of the first battery array.

In a further non-limiting embodiment of any of the foregoing traction battery packs, the component of the thermal barrier system includes a thermal barrier plate arranged between the first battery array and a wire or a coolant line of the traction battery pack.

In a further non-limiting embodiment of any of the foregoing traction battery packs, the foam portion includes a polyurethane foam.

In a further non-limiting embodiment of any of the foregoing traction battery packs, the endothermic aerogel system includes an aerogel additive, an intumescent additive, a melamine powder, and an endothermic additive.

A traction battery pack according to another exemplary aspect of the present disclosure includes, among other things, an enclosure assembly, a first battery array housed within the enclosure assembly, a second battery array housed within the enclosure assembly, a bus bar assembly configured to electrically couple the first and second battery arrays, and a thermal barrier system that includes a bifurcation structure arranged between the first battery array and the second battery array. The bifurcation structure includes a foam portion and an endothermic aerogel system.

In a further non-limiting embodiment of the foregoing traction battery pack, the foam portion includes a polyurethane foam, and the endothermic aerogel system includes an aerogel additive, an intumescent additive, a melamine powder, and an endothermic additive.

In a further non-limiting embodiment of either of the foregoing traction battery packs, the thermal barrier system includes a canopy structure arranged to cover at least a portion of the bus bar assembly.

In a further non-limiting embodiment of any of the foregoing traction battery packs, the canopy structure includes the foam portion and the endothermic aerogel system.

In a further non-limiting embodiment of any of the foregoing traction battery packs, the canopy structure and the bifurcation structure cooperate to isolate a first portion of an interior of the enclosure assembly where the first battery array resides from a second portion of the interior where the second battery array resides.

In a further non-limiting embodiment of any of the foregoing traction battery packs, the thermal barrier system includes a canopy structure arranged to cover a sensitive component of the first battery array or the second battery array.

In a further non-limiting embodiment of any of the foregoing traction battery packs, the canopy structure includes the foam portion and the endothermic aerogel system.

In a further non-limiting embodiment of any of the foregoing traction battery packs, the thermal barrier system includes a thermal barrier plate arranged between the first battery array or the second battery array and a wire or a coolant line of the traction battery pack.

In a further non-limiting embodiment of any of the foregoing traction battery packs, the thermal barrier plate includes the foam portion and the endothermic aerogel system.

In a further non-limiting embodiment of any of the foregoing traction battery packs, the foam portion is impregnated with the endothermic aerogel system.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 is a cross-sectional view of an exemplary traction battery pack that includes a thermal barrier system.

FIG. 3 illustrates additional features of a thermal barrier system of a traction battery pack.

FIG. 4 schematically illustrates a high temperature material system of the components of a thermal barrier system for a traction battery pack.

FIG. 5 schematically illustrates another exemplary high temperature material system of a component of a thermal barrier system for a traction battery pack.

### DETAILED DESCRIPTION

This disclosure details exemplary battery thermal barrier systems for traction battery packs. Exemplary battery thermal barrier systems may include one or more components that include a foam portion and an endothermic aerogel system configured to mitigate the effects of battery thermal events. The components may include bifurcation structures, canopy structures, thermal barrier plates, or combinations thereof. These and other features are discussed in greater detail in the following paragraphs of this detailed description.

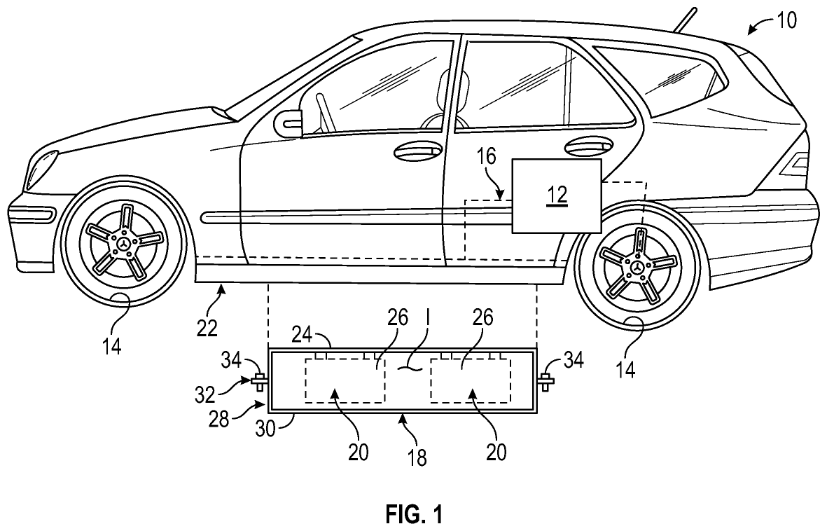

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An outer enclosure assembly 28 may house each battery array 20 of the traction battery pack 18. The outer enclosure assembly 28 may be a sealed enclosure and may embody any size, shape, and configuration within the scope of this disclosure. In an embodiment, the outer enclosure assembly 28 includes an enclosure cover 24 and an enclosure tray 30. Together, the enclosure cover 24 and the enclosure tray 30 may establish an interior I for housing the battery arrays 20 and other battery internal components (e.g., bussed electrical center, battery electric control module, wiring, coolant lines, connectors, etc.) of the traction battery pack 18.

During assembly of the traction battery pack 18, the enclosure cover 24 may be secured to the enclosure tray 30 at an interface 32 therebetween. The interface 32 may substantially circumscribe the interior I. In some implementations, mechanical fasteners 34 may be used to secure the enclosure cover 24 to the enclosure tray 30, although other fastening methodologies (adhesion, etc.) could also be suitable.

From time to time, pressure and thermal energy within one or more of the battery cells 26 can increase. The pressure and thermal energy increase can be due to an overcharge condition, an overdischarging condition, or short circuit events, for example. The pressure and thermal energy increase can cause the associated battery cell 26 to rupture and release gas from within an interior of the associated battery cell 26. The gases may be caused by an applied force or a thermal event, and can either cause or exacerbate an existing battery thermal event. A relatively significant amount of heat can be generated during battery thermal events, and this heat can sometimes cascade from array-to-array within the traction battery pack 18. This disclosure is therefore directed to thermal barrier system designs for mitigating the effects of battery thermal events.

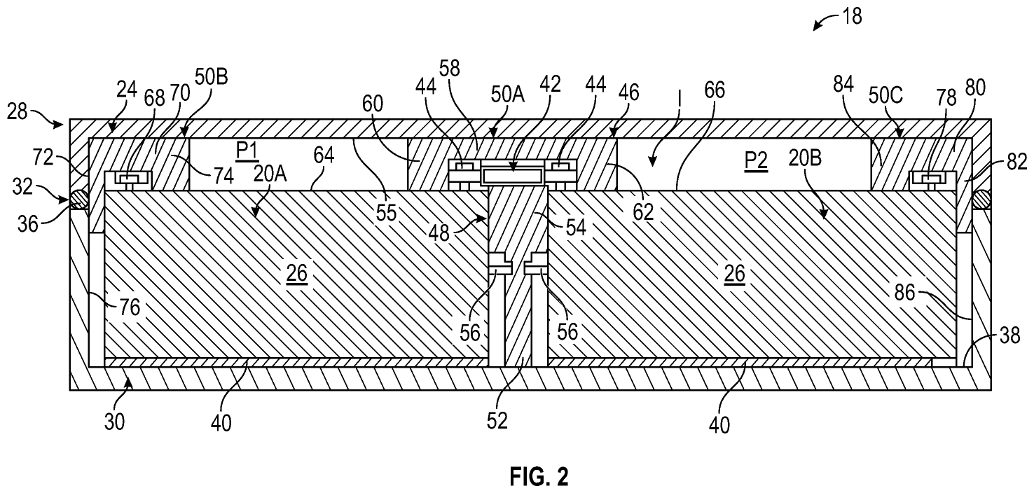

FIG. 2 illustrates further details associated with the traction battery pack 18. The outer enclosure assembly 28 of the traction battery pack 18 may be a sealed enclosure that includes the enclosure tray 30, the enclosure cover 24, and a seal 36. The seal 36 may be disposed between the enclosure tray 30 and the enclosure cover 24 for sealing the interface 32 therebetween. The seal 36 may be a press-in-place seal, a foam seal, a curable seal, or any other type of seal suitable for sealing the interface 32 of the outer enclosure assembly 28.

The enclosure tray 30 and the enclosure cover 24 may be constructed of metallic materials, polymer-based materials, textile materials, or any combination of these materials. In an exemplary embodiment, the enclosure cover 24 is constructed of polymer-based materials and the enclosure tray 30 is constructed of metallic materials. The enclosure cover 24 may therefore include a different material makeup than the enclosure tray 30.

The interior I of the outer enclosure assembly 28 may be established by inner walls/surfaces of both the enclosure tray 30 and the enclosure cover 24. In the illustrated embodiment, the traction battery pack 18 includes a first battery array 20A and a second battery array 20B housed within the interior I. Although depicted as having two battery arrays, the traction battery pack 18 could include a greater number of battery arrays within the scope of this disclosure.

The first battery array 20 and the second battery array 20B may be positioned atop the enclosure tray 30. The enclosure cover 24 may then be received over the first and second battery arrays 20A, 20B and mounted to the enclosure tray 30 to assemble the outer enclosure assembly 28.

The first and second battery arrays 20A, 20B may be received relative to a floor 38 of the enclosure tray 30. The floor 38 may function as a heat exchanger plate or “cold plate” for conducting heat out of the battery cells 26 of the first and second battery arrays 20A, 20B. A thermal interface material 40 may be disposed between each of the first and second battery arrays 20A, 20B and the floor 38. The thermal interface material 40 may include an epoxy resin, a silicone based material, a thermal grease, etc. and is designed to increase the thermal conductivity between the first and second battery arrays 20A, 20B and the enclosure tray 30. Although shown as being an integrated feature of the enclosure tray 30 in this embodiment, a separate “cold plate” structure could alternatively be provided between the thermal interface material 40 and the floor 46.

A bus bar assembly 42 may be utilized to electrically connect the first battery array 20A and the second battery array 20B. The bus bar assembly 42 may be attached to respective terminals 44 of the first and second battery arrays 20A, 20B and is configured to carry electrical current between the first and second battery arrays 20A, 20B for electrically distributing power.

The traction battery pack 18 may additionally include a thermal barrier system 46 configured for mitigating the effects of battery thermal events. For example, among other benefits, the thermal barrier system 46 may be configured to block heat, battery cell vent gases, effluents, etc. from being transferred from battery array-to-battery array during battery thermal events and from influencing the structural integrity of the enclosure cover 24 and/or the enclosure tray 30.

The thermal barrier system 46 may include a bifurcation structure 48 and multiple canopy structures. In an embodiment, the thermal barrier system 46 includes a first canopy structure 50A, a second canopy structure 50B, and a third canopy structure 50C. However, the thermal barrier system 46 could include a greater or fewer number of canopy structures within the scope of this disclosure.

The bifurcation structure 48 may include a mounting pedestal 52 and a partition 54. Although discussed herein individually due to their unique functions, the mounting pedestal 52 and the partition 54 may be integrally formed, such as a unitary, molded construct, for example.

The mounting pedestal 52 may protrude upwardly from the enclosure tray 30 and may be disposed at a location of the interior I that is axially between the first battery array 20A and the second battery array 20B. In an embodiment, the mounting pedestal 52 is an integral component of the enclosure tray 30. In another embodiment, the mounting pedestal 52 is configured as a T-bracket that is fixedly mounted to the enclosure tray 30 for at least partially separating the first battery array 20A from the second battery array 20B.

Each of the first and second battery arrays 20A, 20B may include a mounting flange 56 that may be fixedly mounted (e.g., bolted, welded, etc.) to the mounting pedestal 52. The mounting flange 56 of the first battery array 20A may be mounted at an opposite side of the mounting pedestal 52 from the mounting flange 56 of the second battery array 20B

The partition 54 may extend from an upper portion of the mounting pedestal 52. In an embodiment, the partition 54 is disposed at a location above the portion of the mounting pedestal 52 that receives the mounting flanges 56. The partition 54 may function to substantially seal an interface between the first and second battery arrays 20A, 20B and the bus bar assembly 42.

The first canopy structure 50A may be a hood-like structure that is arranged to cover at least a portion of the bus bar assembly 42. The first canopy structure 50A may be a molded feature of the enclosure cover 24 or could be a separate component that is adhered to an inner surface 55 of the enclosure cover 24.

The first canopy structure 50A may include a base 58, a first arm 60, and a second arm 62. The base 58 may be received at the inner surface 55, and the first arm 60 and the second arm 62 may protrude outwardly in a direction away from the base 58 (e.g., toward the floor 38 of the enclosure tray 30) for interfacing with the first battery array 20A and the second battery array 20B, respectively. The first arm 60 may be received in abutting contact with an upper surface 64 of the first battery array 20A at a location that is slightly outboard of the bus bar assembly 42, and the second arm 62 may be received in abutting contact with an upper surface 66 of the second battery array 20B at a location that is slightly outboard of the bus bar assembly 42. The first canopy structure 50A may thus substantially block the transfer of heat and/or cell vent byproducts, gases, effluents, etc. from the first battery array 20A and/or the second battery array 20B to the bus bar assembly 42, thereby substantially mitigating the likelihood of electrically shorting either of the battery arrays 20A, 20B through the bus bar assembly 42.

Together, the bifurcation structure 48 and the first canopy structure 50A may substantially isolate a first portion P1 of the interior I where the first battery array 20A resides from a second portion P2 of the interior I where the second battery array 20B resides (and vice versa). The first and second portions P1, P2 may establish venting chambers for conveniently and expeditiously venting battery cell vent gases and other effluents from the interior I. The thermal barrier system 46 is therefore equipped to limit the array-to-array transfer of heat, cell vent byproducts, gases, effluents, etc. during battery thermal events.

The second canopy structure 50B may be a hood-like structure that is arranged to cover at least a portion of a sensitive component 68 (e.g., a terminal or other component) of the first battery array 20A. The second canopy structure 50B may be a molded feature of the enclosure cover 24 or could be a separate component that is adhered to the inner surface 55 of the enclosure cover 24.

The second canopy structure 50B may include a base 70, a first arm 72, and a second arm 74. The base 70 may be received at the inner surface 55, and the first arm 72 and the second arm 74 may protrude outwardly in a direction away from the base 70 (e.g., toward the floor 38 of the enclosure tray 30). The first arm 72 may seal an interface between a first wall 76 of the enclosure tray 30 and the first battery array 20A. The second arm 74 may be received in abutting contact with the upper surface 64 of the first battery array 20A at a location that is slightly outboard of the sensitive component 68.

The third canopy structure 50C may be another hood-like structure that is arranged to cover at least a portion of a sensitive component 78 (e.g., a terminal or other component) of the second battery array 20B. The third canopy structure 50C may be a molded feature of the enclosure cover 24 or could be a separate component that is adhered to the inner surface 55 of the enclosure cover 24.

The third canopy structure 50C may include a base 80, a first arm 82, and a second arm 84. The base 80 may be received at the inner surface 55, and the first arm 82 and the second arm 84 may protrude outwardly in a direction away from the base 80 (e.g., toward the floor 38 of the enclosure tray 30). The first arm 82 may seal an interface between a second wall 86 of the enclosure tray 30 and the second battery array 20B. The second arm 84 may be received in abutting contact with the upper surface 66 of the second battery array 20B at a location that is slightly outboard of the sensitive component 78.

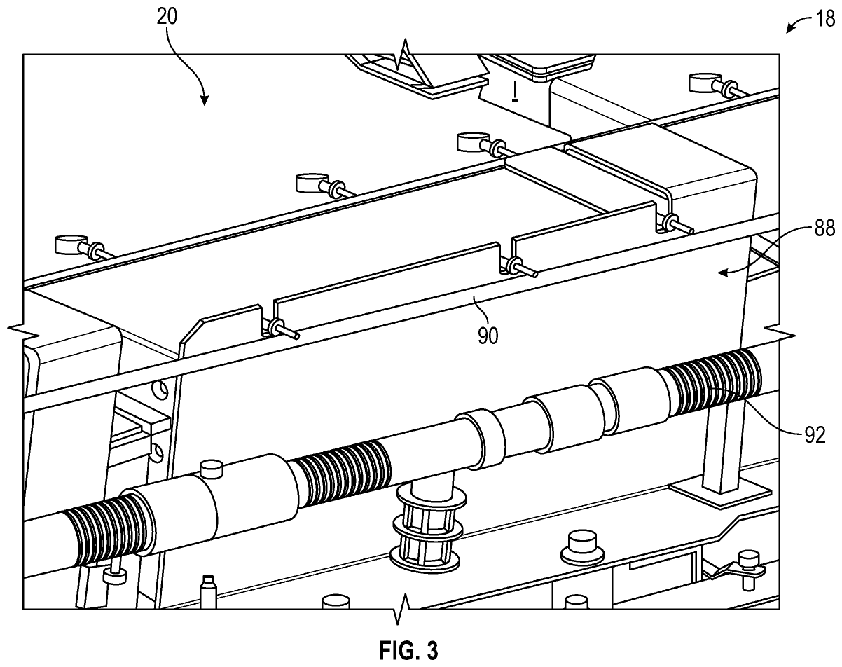

Referring to FIG. 3 (with continued reference to FIGS. 1 and 2), the thermal barrier system 46 may additionally include one or more thermal barrier plates 88 positioned throughout the interior I of the traction battery pack 18. The thermal barrier plate 88 may be positioned between a battery array 20 and portions of an electrical distribution system (EDS) and/or a coolant system of the traction battery pack 18. In an embodiment, the thermal barrier plate 88 is positioned between the battery array 20 and a wire 90 of the EDS and/or a coolant line 92 of the cooling system. The thermal barrier plate 88 may be configured to thermally insulate the wire 90 and/or the coolant line 92 and protect these components from heat, cell vent byproducts, gases, effluents, etc. during battery thermal events.

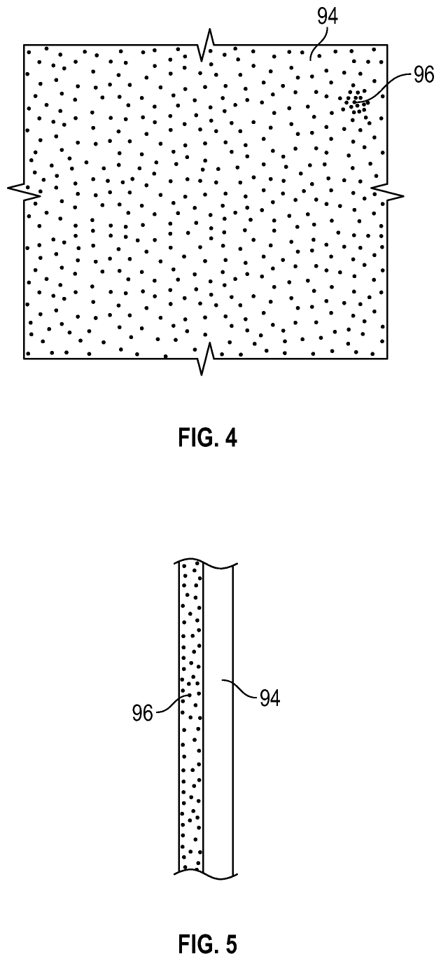

Referring to FIG. 4 (with continued reference to FIGS. 1-3), the various components (e.g., the bifurcation structure 48, the canopy structures 50A, 50B, 50C, and the thermal barrier plates 88) of the thermal barrier system 46 may be made of a high temperature material system that includes a foam portion 94 and an endothermic aerogel system 96. In an embodiment, the foam portion 94 may be impregnated with the endothermic aerogel system 96 (see FIG. 4). In another embodiment, the endothermic aerogel system 96 may be configured as a sheet-like structure that can be adhered to the foam portion 94 (see FIG. 5).

The foam portion 94 may include a polyurethane foam. However, other foam materials or combinations of materials could alternatively or additionally be utilized within the scope of this disclosure.

The endothermic aerogel system 96 may include a non-woven ceramic fiber that includes various integrated fillers. In an embodiment, the endothermic aerogel system 96 includes aerogel additives (about 1-2%), intumescent additives (about 0.5-3.0%), melamine powder (about 0.5-1.2%), and endothermic additives (about 1-1.2%), with each substituent component defined as a percentage by weight relative to the total weight of the formulation. However, other formulations are contemplated within the scope of this disclosure. Furthermore, in this disclosure, the term “about” means that the expressed quantities or ranges need not be exact but may be approximated and/or larger or smaller, reflecting acceptable tolerances, conversion factors, measurement error, etc.

In an embodiment, the aerogel additives may include silica or metal oxides, the intumescent additives may include expandable graphene or mono ammonium phosphate, and the endothermic additives may include aluminum trihydrate or sodium silicate. However, other materials or combinations of materials may be utilized within the endothermic aerogel system 96 within the scope of this disclosure.

The endothermic aerogel system 96 may be configured to withstand relatively high temperatures that can develop within the traction battery pack 18, such as during battery thermal events. For example, the material may be configured to withstand temperatures of about 700°-800° C. for a continuous exposure of about 5 minutes. The endothermic aerogel system 96 may further be configured to withstand temperatures of up to about 1000° C. for a short duration (e.g., less than about 40 seconds).

The endothermic aerogel system 96 may be further configured to expand during some battery thermal events. For example, when the temperature inside the traction battery pack 18 exceeds a predefined temperature threshold (e.g., between about 120° C. and about 200° C.), the endothermic aerogel system 96 may expand in order to absorb heat and withstand high velocity gas particles, thereby preserving the structural integrity of the enclosure cover 24 and/or the enclosure tray 30.

The exemplary thermal barrier systems of this disclosure are designed to incorporate endothermic aerogel systems for mitigating the effects of battery thermal events within a traction battery pack. The systems may provide numerous advantages over known solutions, including but not limited to presenting a novel configuration that significantly slows or even prevents the array-to-array transfer of the battery thermal event.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly;
a first battery array housed within the enclosure assembly; and
a thermal barrier system including a component arranged to interface with at least one of the enclosure assembly or the first battery array,
wherein the component includes a foam portion and an endothermic aerogel system.

2. The traction battery pack as recited in claim 1, wherein the component of the thermal barrier system includes a bifurcation structure that is positioned between the first battery array and a second battery array.

3. The traction battery pack as recited in claim 2, wherein the bifurcation structure includes a mounting pedestal extending between the first battery array and the second battery array and a partition arranged to seal an interface between the first battery array, the second battery array, and a bus bar assembly.

4. The traction battery pack as recited in claim 1, wherein the component of the thermal barrier system includes a canopy structure arranged to cover at least a portion of a bus bar assembly that electrically couples the first battery array to a second battery array.

5. The traction battery pack as recited in claim 4, wherein the canopy structure and a bifurcation structure of the thermal barrier system cooperate to isolate a first portion of an interior of the enclosure assembly where the first battery array resides from a second portion of the interior where the second battery array resides.

6. The traction battery pack as recited in claim 1, wherein the component of the thermal barrier system includes a canopy structure arranged to cover a sensitive component of the first battery array.

7. The traction battery pack as recited in claim 6, wherein the canopy structure includes a first arm that is arranged to contact a wall of an enclosure tray of the enclosure assembly and a second arm that is arranged to contact an upper surface of the first battery array.

8. The traction battery pack as recited in claim 1, wherein the component of the thermal barrier system includes a thermal barrier plate arranged between the first battery array and a wire or a coolant line of the traction battery pack.

9. The traction battery pack as recited in claim 1, wherein the foam portion includes a polyurethane foam.

10. The traction battery pack as recited in claim 1, wherein the endothermic aerogel system includes an aerogel additive, an intumescent additive, a melamine powder, and an endothermic additive.

11. A traction battery pack, comprising:
an enclosure assembly;
a first battery array housed within the enclosure assembly;
a second battery array housed within the enclosure assembly;
a bus bar assembly configured to electrically couple the first and second battery arrays; and
a thermal barrier system that includes a bifurcation structure arranged between the first battery array and the second battery array,
wherein the bifurcation structure includes a foam portion and an endothermic aerogel system.

12. The traction battery pack as recited in claim 11, wherein the foam portion includes a polyurethane foam, and the endothermic aerogel system includes an aerogel additive, an intumescent additive, a melamine powder, and an endothermic additive.

13. The traction battery pack as recited in claim 11, wherein the thermal barrier system includes a canopy structure arranged to cover at least a portion of the bus bar assembly.

14. The traction battery pack as recited in claim 13, wherein the canopy structure includes the foam portion and the endothermic aerogel system.

15. The traction battery pack as recited in claim 13, wherein the canopy structure and the bifurcation structure cooperate to isolate a first portion of an interior of the enclosure assembly where the first battery array resides from a second portion of the interior where the second battery array resides.

16. The traction battery pack as recited in claim 11, wherein the thermal barrier system includes a canopy structure arranged to cover a sensitive component of the first battery array or the second battery array.

17. The traction battery pack as recited in claim 16, wherein the canopy structure includes the foam portion and the endothermic aerogel system.

18. The traction battery pack as recited in claim 11 wherein the thermal barrier system includes a thermal barrier plate arranged between the first battery array or the second battery array and a wire or a coolant line of the traction battery pack.

19. The traction battery pack as recited in claim 18, wherein the thermal barrier plate includes the foam portion and the endothermic aerogel system.

20. The traction battery pack as recited in claim 11, wherein the foam portion is impregnated with the endothermic aerogel system.
